(19) United States
(12) Patent Application Publication
(10) Pub. No.: US 2008/0122675 A1
(43) Pub. Date: May 29, 2008

(54) UNIVERSAL REMOTE CONTROL PROGRAMMING AND OPERATIONS PLATFORM

(76) Inventors: John Bilodeau, Las Vegas, NV (US); Charles Henry R. Blagitz, Sao Paulo (BR); Thais Campas, Sao Paulo (BR)

Correspondence Address: GREENBERG TRAURIG, 3773 HOWARD HUGHES PARKWAY, SUITE 500 NORTH, LAS VEGAS, NV, 89169, US

(21) Appl. No.: 11/426,904

(22) Filed: Jun. 27, 2006

(51) Int. Cl. H04L 17/02

(52) U.S. Cl. 341/176

(57) ABSTRACT

Described is a modular software- and web-based system for creating a single control interface whereby multiple hardware devices, regardless of compatibility, may be controlled by the user. A user-friendly graphical user interface (GUI) or non-GUI (e.g., buttons) provide a web-based system for a user to effectively control multiple hardware devices (e.g., television, DVD, receiver, surveillance cameras, lights, etc.). A kit, including templates for the creation of GUI assembly modules, non-GUI assembly modules, device code blocks and also templates for hardware control interfaces (HCIs) allows users to create a control interface commensurate with their programming skill level and to personalize the interface into an environment reflecting the users' personalities, moods and interests. Open architecture and open source encourages an ever-changing software platform to keep up with new hardware devices and related technological advancements.

### FIELD OF THE INVENTION

The embodiments of the present invention relate to a universal, open architecture system designed to interconnect various graphical user interfaces and hardware control interfaces. The system is facilitated by a modular architecture having multiple layers and which allows users to personalize the platform into an environment reflecting the users' personalities, moods and interests.

### BACKGROUND

Current hardware and integral software, such as that used for security systems, audio-visual systems or industrial monitoring for example, is often proprietary in nature. In other words, the software controlling the hardware is different and proprietary to each manufacturer. With so many manufacturers of the same hardware, at least from an application standpoint, it is difficult for end users to create a universal control system capable of controlling components from various manufacturers. That is, one manufacturer's components do not generally communicate with another manufacturer's components. Thus, users are compelled to purchase only one manufacturer's components or undertake difficult solutions for developing an overall control system with components manufactured by different companies, each being controlled by a different proprietary software system.

Open source code has seen a rise in popularity because of the ability to more conveniently improve and repair the code in an efficient manner. Open source code is a move away from the proprietary code systems being utilized by many of the world's largest companies. The most well-known open source success to date is the Linux operating system. The Linux operating system continues to gain market share on Microsoft's Windows®, due in part to its versatility and user access. Nonetheless, the open architecture model has yet to adequately infiltrate the electronics market.

Thus, there exists the need for a universal remote control system permitting a user to control different hardware devices from a single interface (e.g., GUI). Moreover, the remote control system should be open architecture and open source allowing users to manipulate it for specific, user- and community-defined purposes.

### SUMMARY

Without limiting the scope of coverage and for purposes of explaining the embodiments of the present invention, some objectives of the embodiments of the present invention include creating a unifying, modular platform between different graphical user interfaces and hardware control interfaces and creating a user-friendly and open remote control system useable to facilitate countless different control applications.

The World Wide Web (“web”) has compelled the development of web-enabled hardware devices capable of being controlled via the web by means of web clicks on webpages. For example, home appliances, LCD projectors and security systems are now web-enabled such that they may be controlled via the web and designated web pages. To facilitate the web-enabled hardware, certain companies provide web access whereby users program a web page providing the hooks through an operating system to hardware devices connected to the hooks. Such systems provide real-time feedback and customizable graphical user interfaces. The advent of the web-enabled devices has not proliferated as one would expect because the manufacturers of the hardware devices have focused on their own product to the detriment of the consumer.

The embodiments of the present invention overcome the drawbacks of the previous systems by utilizing open source or ubiquitous web languages and software-driven applications such as Sun Java or Macromedia Flash that provide a common programming platform through which all types of hardware devices can be controlled or through which other devices can be controlled.

A first method embodiment of the present invention comprises: providing a web-based system platform; providing templates operable to allow users to create system modules, including GUI assembly modules, non-GUI assembly modules and/or device code block modules, wherein the modules are open architecture and open source and comprise a template layer, an applications layer and a communications layer, said GUI assembly and non-GUI assembly modules being hooked into the system and the device code block modules being hooked into the GUI assembly modules and non-GUI assembly modules, said GUI assembly modules and non-GUI modules able to mate with hardware control interfaces; and providing means for a user to create a single interface for controlling multiple hardware devices connected to said system.

A first system embodiment of the present invention comprises: a web-based system platform; open architecture system modules comprising GUI assembly modules, non-GUI assembly modules and/or device code block modules, said modules comprising a template layer, an applications layer and a communications layer wherein the template layer faces a user and said applications layer faces the communications layer; a layered configuration of modules wherein said GUI assembly modules and non-GUI assembly modules are hooked into the system and the device code block modules are hooked into the GUI assembly modules and non-GUI assembly modules, said GUI assembly modules and non-GUI modules able to mate with hardware control interfaces; and a user interface operable for a user to control multiple hardware devices connected to said system.

Other variations, embodiments and features of the present invention will become evident from the following detailed description, drawings and claims.

### BRIEF DESCRIPTION OF THE DRAWINGS

FIG. 1 illustrates a representative diagram of a system according to the embodiments of the present invention;

FIGS. 2a-2n illustrate sequential user screens for a user to create a GUI for controlling multiple hardware devices; and

FIGS. 3a-3d illustrate exemplary GUIs for controlling the multiple connected hardware devices.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention claimed.

By way of background and to fully understand the objectives and purposes of the embodiments of the present invention, a current problem is detailed via the following scenario. Currently, hardware devices, like a surveillance systems, are capable of being controlled via a personal computer over the web. Such control includes streaming video from security cameras and turning security lights on and off. Such control is facilitated by a web interface built into a surveillance system control server. It would be beneficial to permit other systems, such as home theatre systems and heating and air conditioning systems, to be controlled via the same control interface. Unfortunately, the home theatre system and the home surveillance system often times do not talk or communicate with one another since each is an individual application. From a web browser it is possible, assuming that the two systems are web-enabled and securely available over a closed local area network (LAN), a virtual private network (VPN) or otherwise secured system, that the control applications of each system may be accessed individually. However, in so doing, a user must continually switch between two control interfaces depending on which device the user desires to control. Moreover, some control application systems may support VPN access while others may not be web-enabled. Integrating such hardware devices and web-based applications across a common platform is tremendously expensive and labor intensive from a programming standpoint. In addition, the advancement in technology requires constant system updates adding to the overall cost.

The embodiments of the present invention overcome the shortcomings of the current systems and facilitate a universal control interface for multiple different devices and applications.

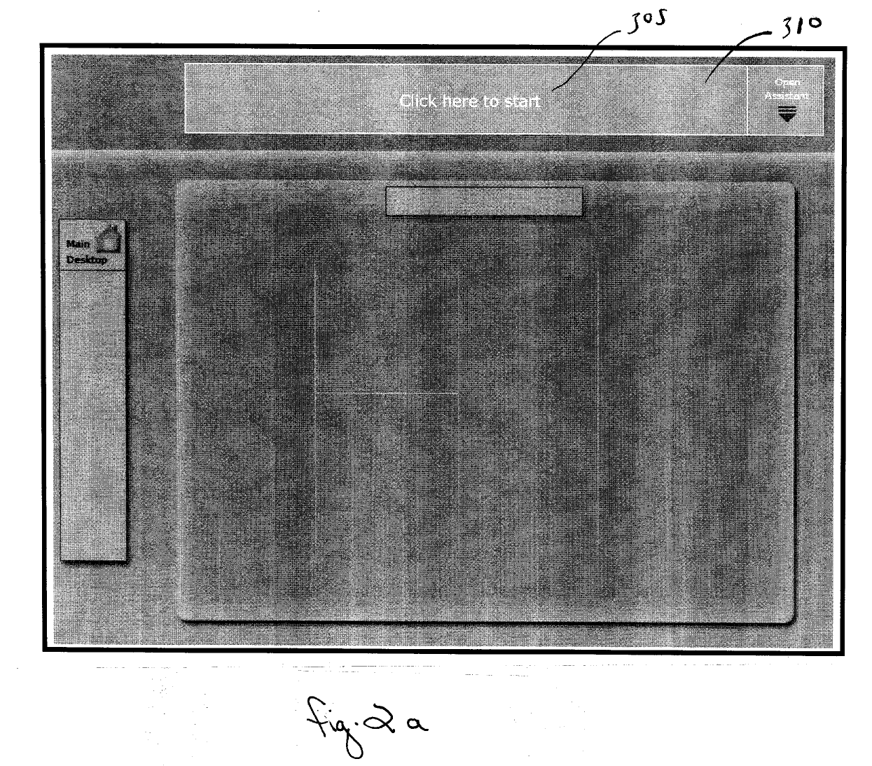

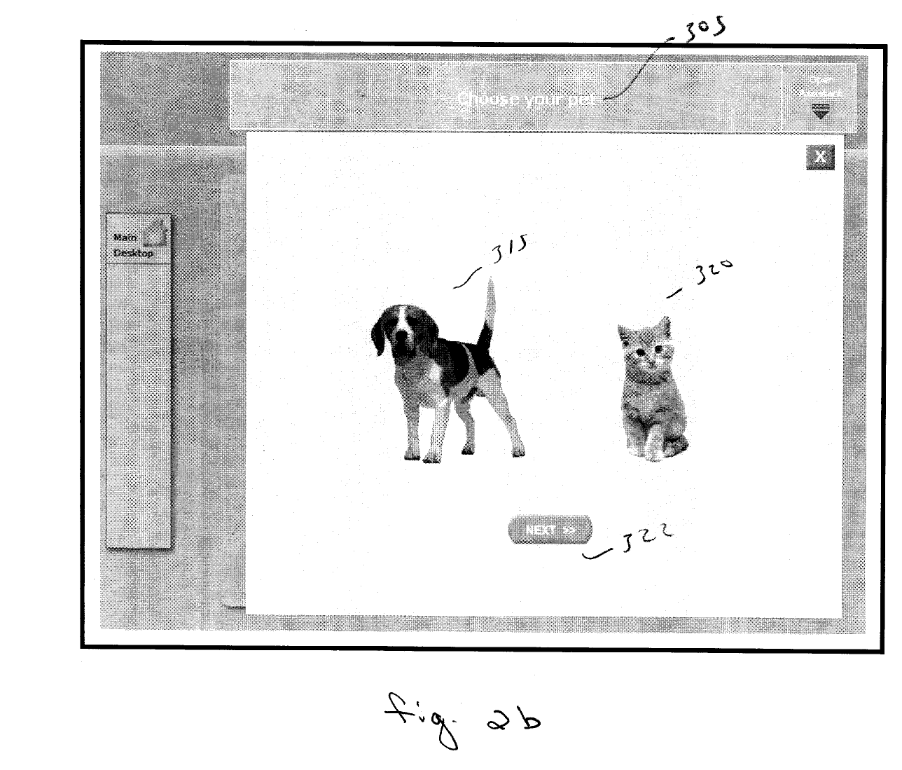

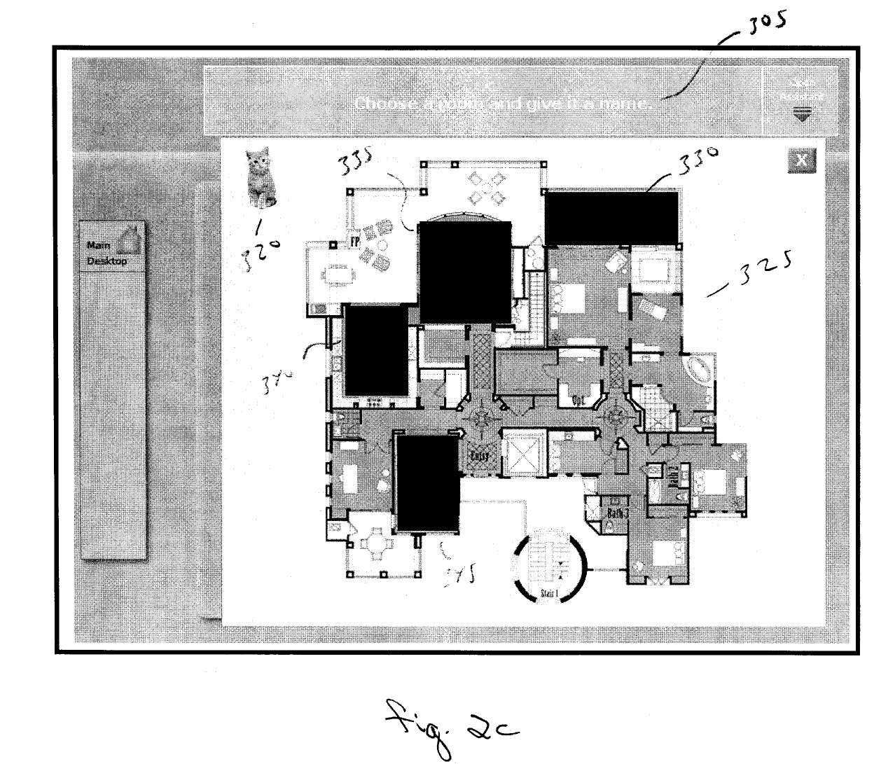

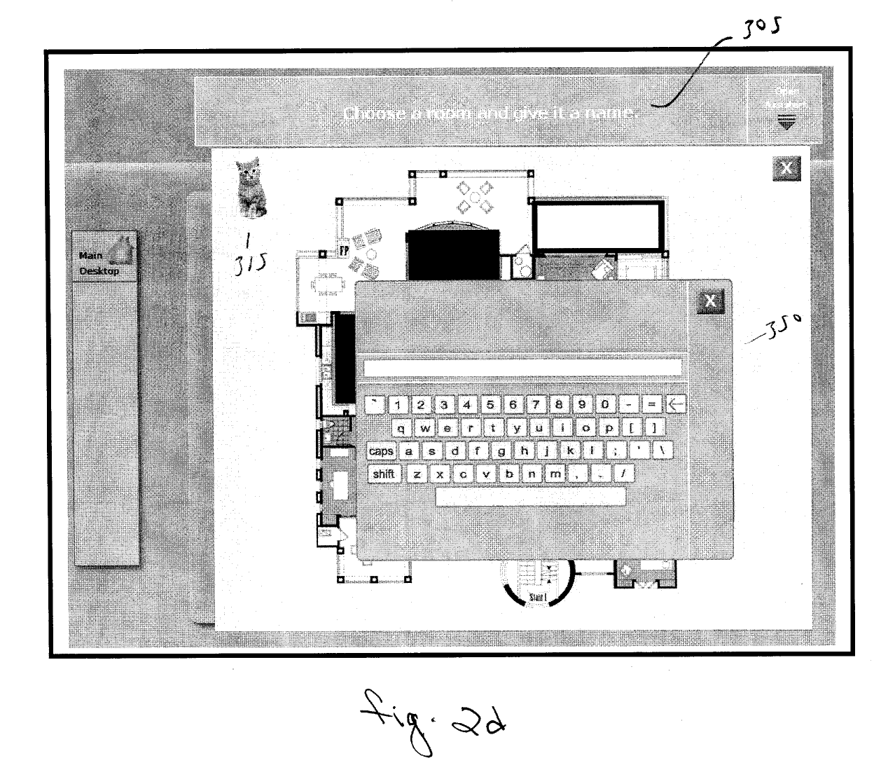

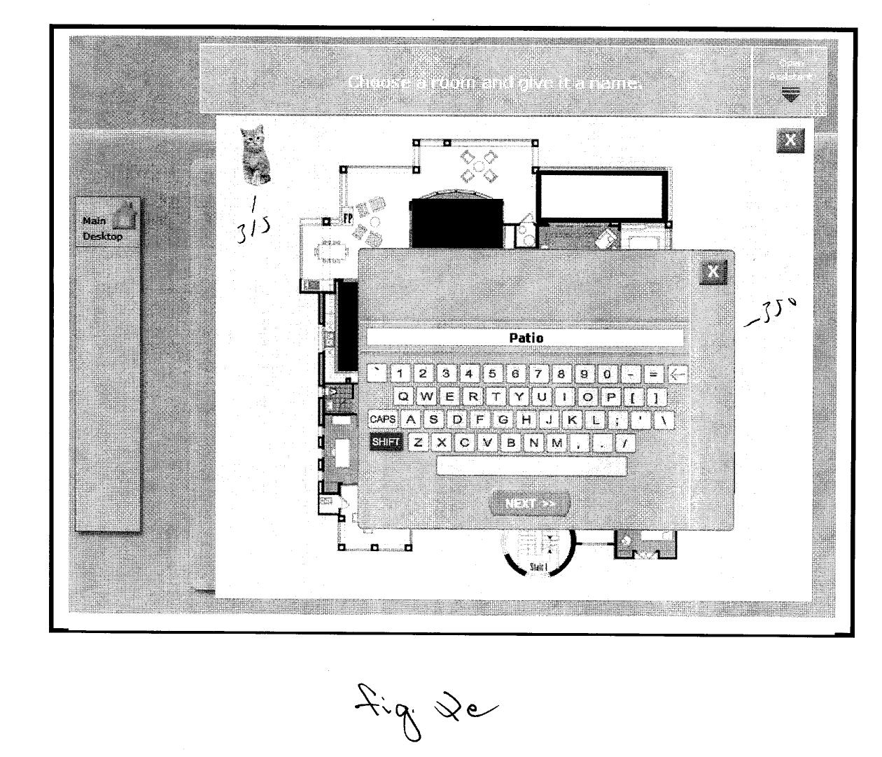

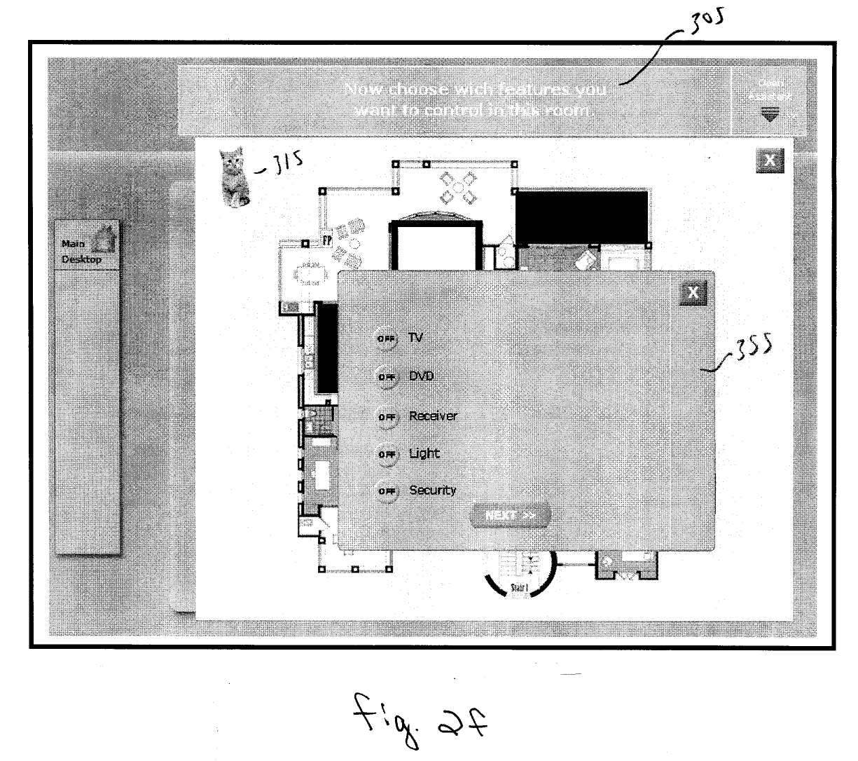

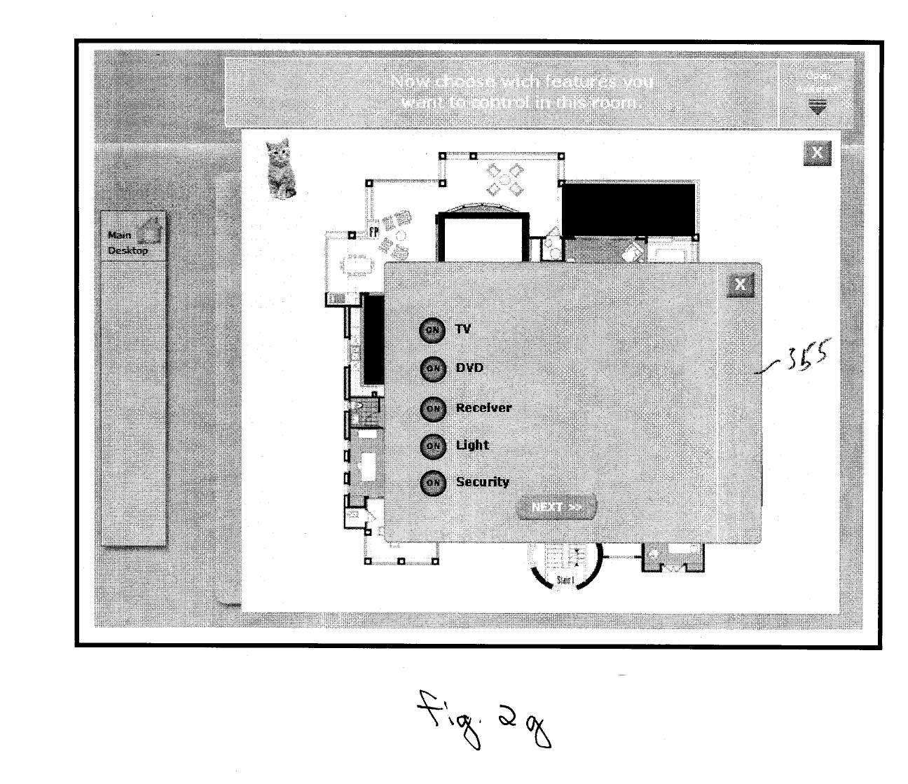

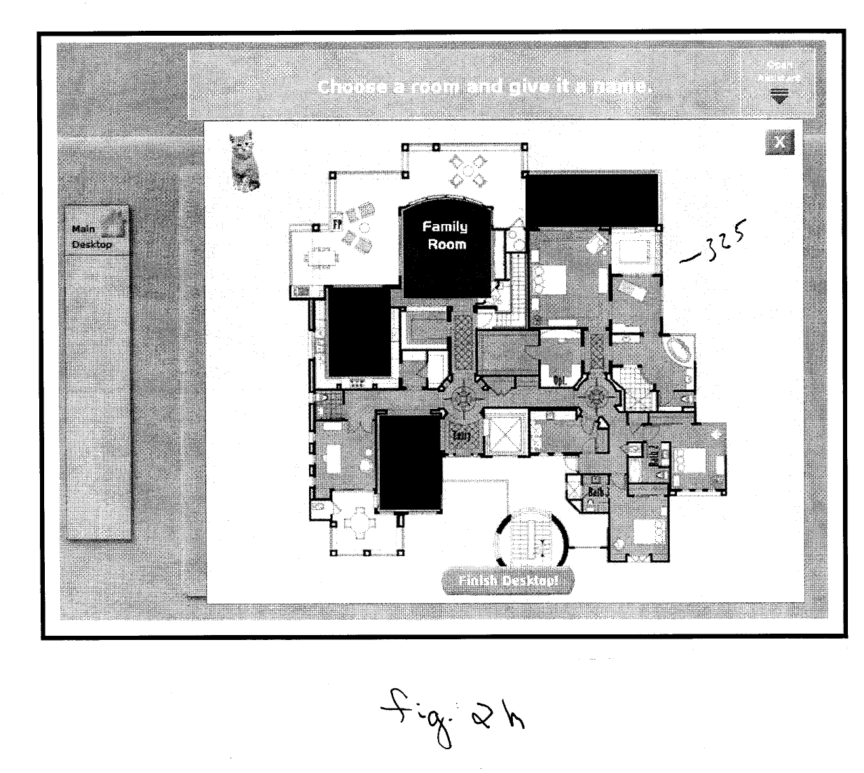

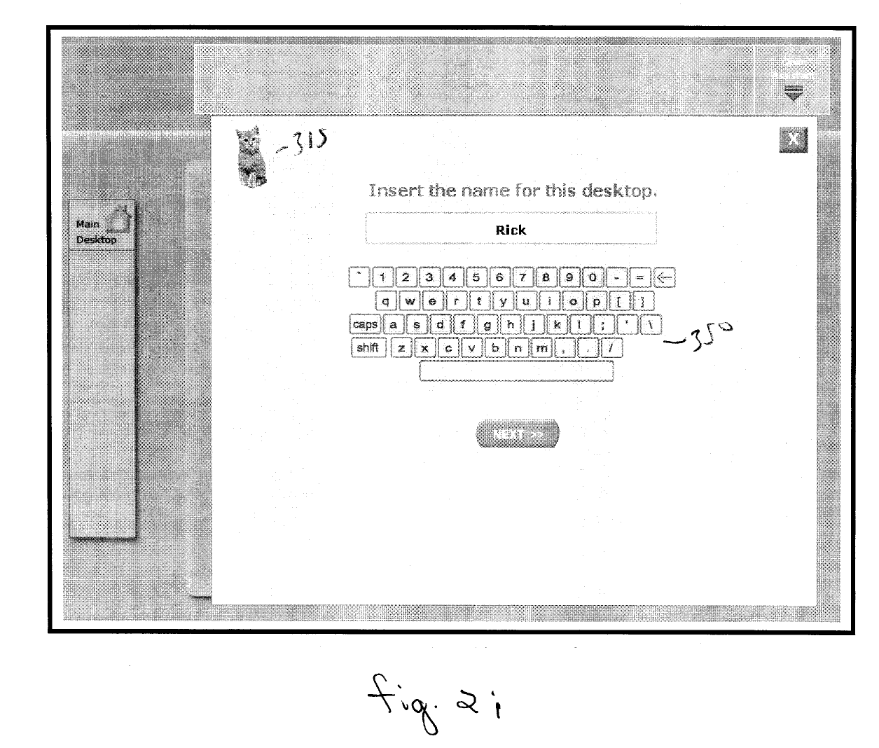

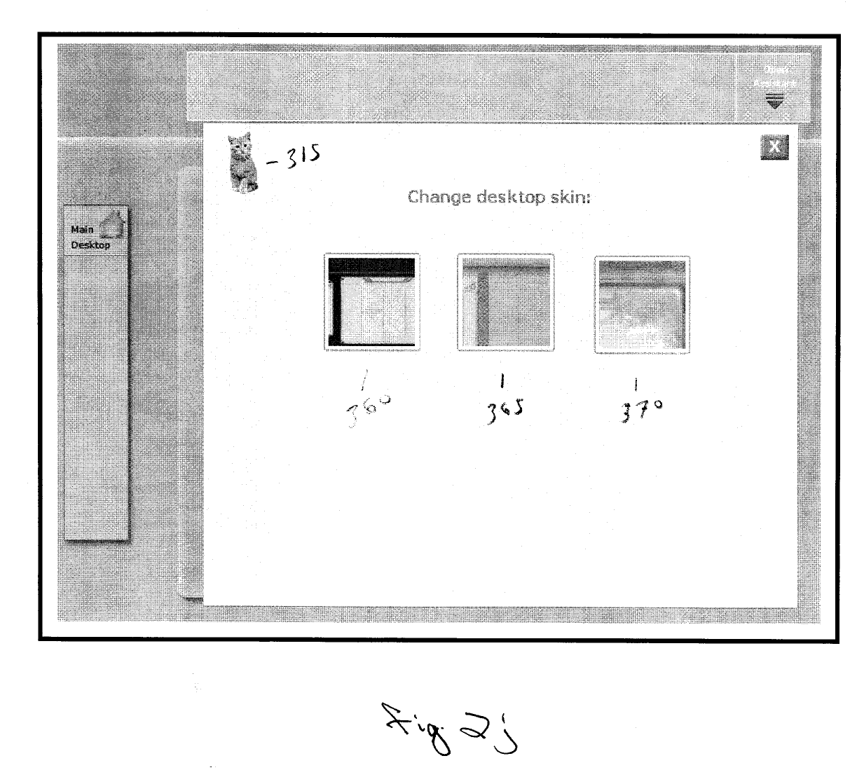

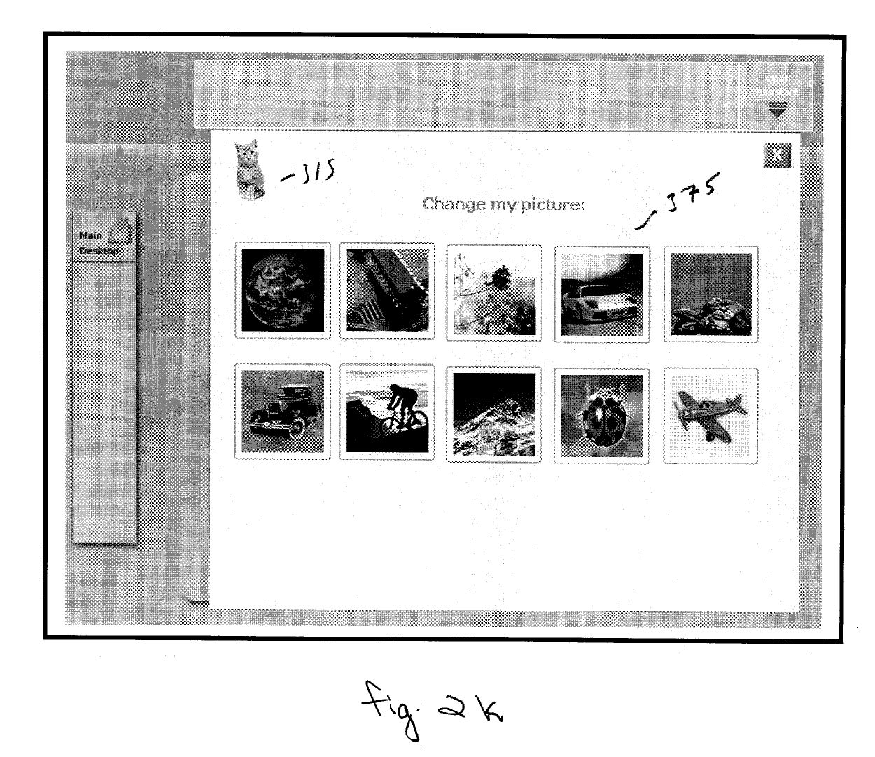

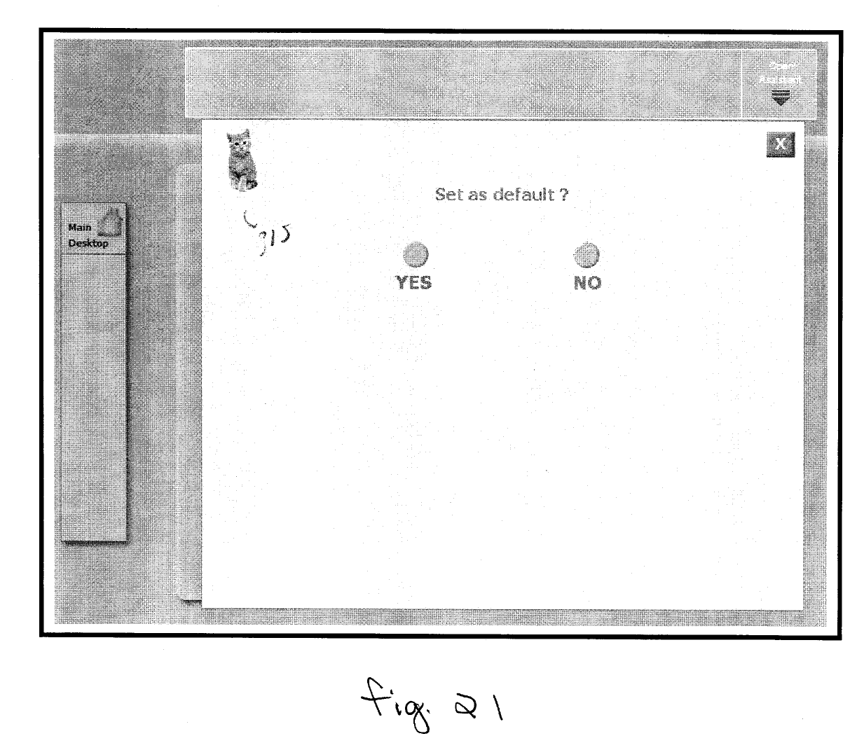

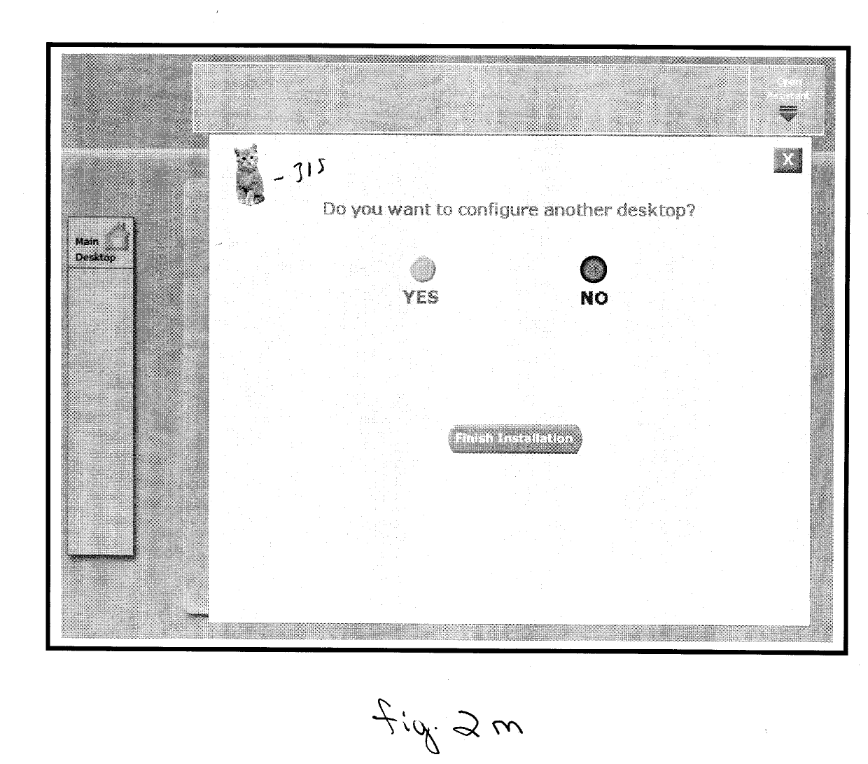

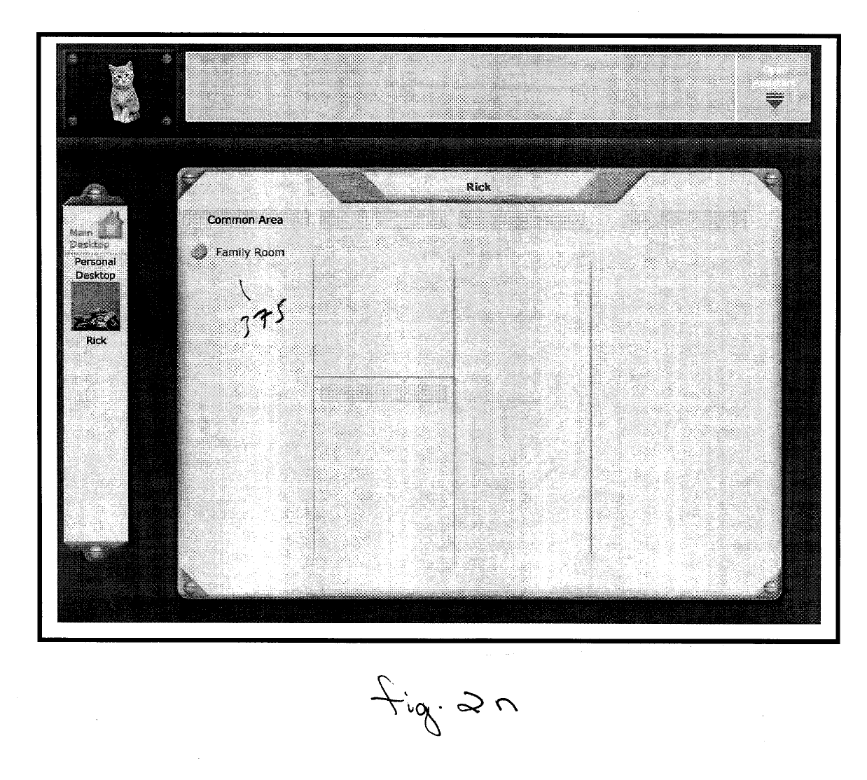

The embodiments of the present invention utilize customizable templates for different web pages involved with a control environment. Consequently, users may personalize the templates into an environment reflecting the users' personalities, moods and interests. The embodiments of the present invention facilitate a flexible system such that users having varying skill sets are able to benefit from the system commensurate with their level of expertise. For many users, a personalized interface akin to a personal computer desktop screen is adequate to meet their system control needs. Such a personalized interface can include the incorporation of digital photos, personal artwork and drag and drop layouts as detailed in FIGS. 2a-2n below. A next level of users have moderate programming skills such that they fall into an experimenter category. The system allows these users to create device control modules which hook into the system. These experimenters can access a library of control device modules created through a standardized template to guide the creation of control modules. For high level users, a software development kit (SDK) without a core platform is available. The SDK includes a guide detailing how the device control module hooks can be integrated into different web page programming languages for the creation of unique device control modules.

One system embodiment of the present invention operates from a web server device like the Aurora Multimedia WACI series of control interfaces or a personal computer. Since the system is a web-based application, it works across most known operating systems and web browsers. Because of the universal acceptance of the Internet as a common platform across operating systems, web browsers and languages, the use of web programming languages allows the present system to provide significant user accessibility. However, due to the types of devices and countless user interfaces, the present system does not require, but may include, a web page GUI. Rather than GUIs, non-GUIs, including simple buttons or contact closures, re-tasked IR or RF signals, voltage or current sensing inputs or other types of signal inputs such as electric eye beams, ultrasonic reflection, voice recognition and/or biometrics can be used to facilitate and execute commands across the system.

Systems based on the embodiments of the present invention support several design concepts and objectives. First, permitting the system to be easily and efficiently developed to cover new equipment, hardware, systems and controls via the system's modular design. Second, allowing version upgrades, new control modules and access to new equipment controls via the web. Third, allowing development and integration with ever-changing operating system features and related software advancements.

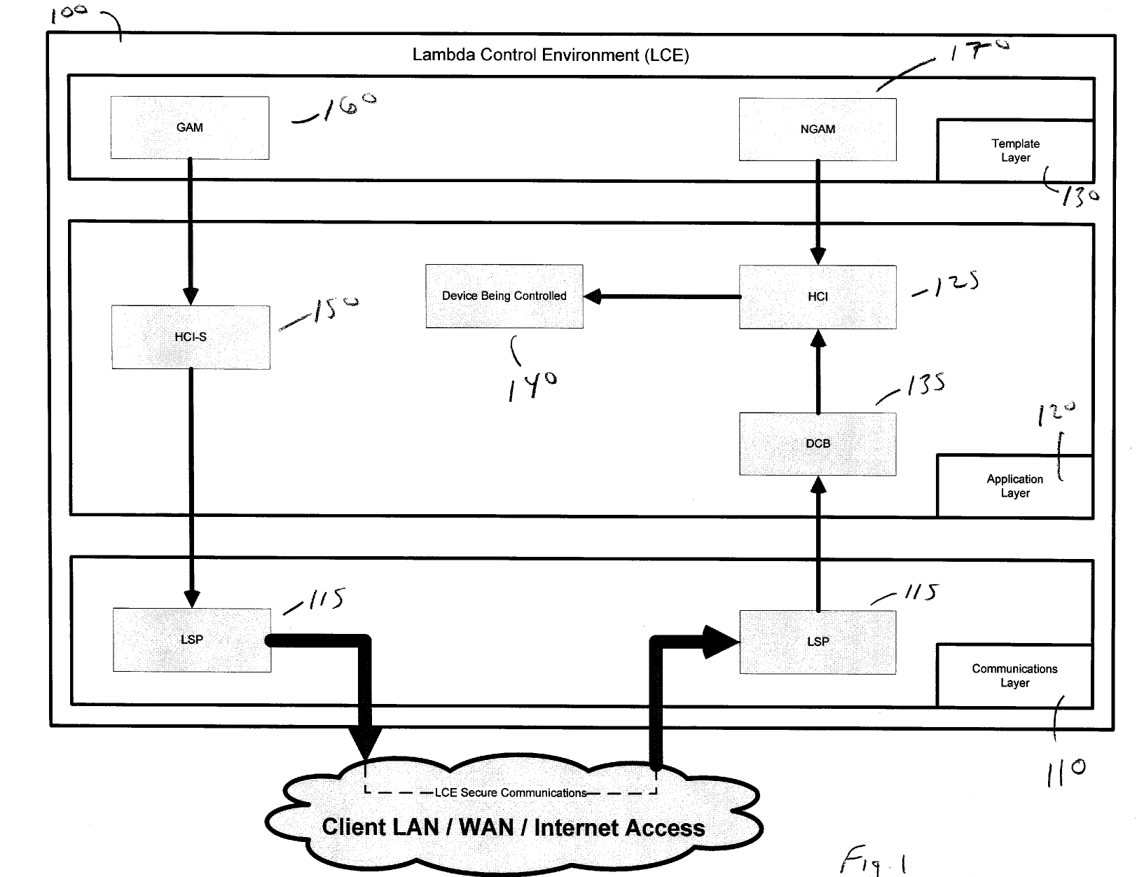

Now, initial reference is made to FIG. 1 illustrating a representative diagram of a system of one embodiment of the present invention and generally referred to by reference numeral 100. The system 100 comprises a communications layer 110, applications layer 120 and template layer 130. The communications layer 110 includes a security platform (LSP) 115 and is able to communicate with a local area network (LAN), wide area network (WAN) or access the Internet. The applications layer 120 includes hardware control interfaces (HCIs) 125, device code blocks 135 and communication means with devices 140 being controlled. A HCI server (HCI-S) 150 also resides on the applications layer 120. The template layer 130 includes GUI assembly modules 160 and non-GUI assembly modules 170. More particularly, the system 100 is a web-based remote control system that, at a front end (template layer 130), permits users to design their own graphical user interface (GUI) in common web programming languages and personalize the templates into an environment reflecting the users' personalities, moods and interests. On a back end (the communications layer 110), the system 100 utilizes command inputs by the user, via the user-created GUI, to drive the hardware control interfaces (HCIs) 125 thereby controlling multiple connected hardware devices 140. The HCIs 125 may comprise commercially available control modules by companies, including, but not limited to, Aurora Multimedia, Moxa, AMX, Extron, Global Cache, Xantech, Russound, SP Controls and Lantronix. The system 100 comprises a modular architecture such that GUI assembly modules 160 and non-GUI assembly modules 170 are mated with the HCIs 125. In this configuration, the system 100 functions as a protocol translator thereby allowing devices 140 running dissimilar protocols to communicate with one another.

To facilitate the communication between the dissimilar protocols, the device code blocks 135 which interface with HCI firmware to produce executable commands to the hardware devices 140 are either buffered such that their device command payloads are parsed from the system 100 through the HCIs 125 or loaded into the HCIs 125 from the system 100 or the device manufacturer's own library as described in more detail below. Therefore, besides functioning as a protocol translator, the system 100 also functions as a transport manager for the device command payloads parsed from the device code blocks 135 as the user issues commands from a GUI assembly module 160 or as event triggers occur, such as contact closures from a non-GUI assembly module 170 to a subject HCI 125. In this manner, a device code block library is constructed in a uniform and predictable manner, much like a dynamic link library, through programming or management through a system template.

In practice, the system 100 functions as a translating, interconnecting and unifying platform between different GUIs and HCIs 125. The communications layer 110 acts as a transport layer between the various modules as described below and is protected by various means, including one or more of the following: code lock down, source code compiling, source code encryption hardware passkeys (e.g., dongles), software passkeys (e.g., registration codes), etc. The GUI assembly modules 160, non-GUI assembly modules 170 and/or device code blocks 135 which form a portion of the system 100 are open architecture and open source and reside on the template layer 130 and the applications layer 120 as described below. Such a configuration permits uniformity, security and ease of on-going development for the benefit of its users.

In one commercial embodiment, users are provided a software-based kit containing templates for the creation of GUI assembly modules 160, non-GUI assembly modules 170, and device code blocks 135. The templates provide the hooks into the communications layer 110 and are ideal for users having a moderate level of computer programming experience. For users with little or no programming experience, the kits include pre-programmed GUI assembly modules 160, non-GUI assembly modules 170 and device code blocks 135 or those that are developed by highly experienced contract programmers under the supervision or control of the kit provider. Such contract programmers shall have a level of experience allowing them to create the GUI assembly modules 160, non-GUI assembly modules 170 and device code blocks 135 without the templates. It is envisioned that the high level programmers will be certified by the kit provider to ensure that the programmer has the necessary skill level to competently create the GUI assembly modules 160, non-GUI assembly modules 170 and device code blocks 135.

More particularly, each GUI assembly module 160 and non-GUI assembly module 170 is based on a template specific to one or more web languages (e.g., Flash, Java, HTML, etc.) for which it is written. The device code blocks 135 have program hooks nested in the GUI assembly modules 160 and non-GUI assembly modules 170 which are themselves integrated into the system 100 with their own program hooks. Each GUI and non-GUI assembly module 160, 170 integrates with a device control block 135. This layered configuration provides a means to separate, while maintaining, different levels of user interaction based on user skill levels. Moreover, standard templates also facilitate the production of uniform programming modules than with non-standard templates.

The GUI and non-GUI assembly modules 160, 170 connect to the applications layer 120. The applications layer 120 is written in any stable web-based language, such as Java or Flash, and runs on any stable operating system such as Windows or Linux. A hosting web server is used to serve up system platform webpages. The hosting web server may be a computer or appliance and, ideally, can operate in a client-server or server-server mode. The web server can also be an HCI 125. Multiple HCIs 125 capable of hosting the system 100 may provide redundant, failover or segmented operation depending upon the manner in which the system is programmed by or for the user.

Each module in this embodiment comprises three layers, namely the template layer 130, applications layer 120 and communications layer 110. As set forth above, the template layer 130 is on the front end and is open or faces the user. The applications layer 120 faces the communications layer 110 and is secured in an interoperative manner therewith. This configuration eliminates security holes including hacker embedded vulnerabilities, hidden viral payloads and similar types of malicious code. Simultaneously, the template layer 130 guides the programming process facilitating efficient code development at the user level. Since the system 100 is open source, the system 100 and associated hooks may be used to authenticate code by date and time or other common methods. Such authentication will provide a means for protecting and identifying code created by certified programmers and also tracking other program related matters. In addition, the scalable and flexible modular architecture allows the system 100 to support all primary programming languages such as Flash, Java, HTML, asp, etc.

To facilitate a commercial embodiment of the present invention, users are provided kits which permit assembly of web pages with controlled access to a website library of GUI assembly modules 160, non-GUI assembly modules 170 and/or device code blocks 135. Ideally, the library is maintained and updated regularly to most effectively and broadly cover any and all available and newly developed hardware devices.

Controlling the attached hardware devices 140 results in the development of three libraries comprising different program modules, namely GUI or non-GUI assembly module templates, device control block templates and HCI templates. This modular configuration allows the system 100 to interoperate with a high majority of web languages and browsers for which the modules are created by virtue of the applications layer 120 embedded hooks working in conjunction with the system 100. The modular design also facilitates efficient addition of modules and upgrades to specific modules within the system without having to impact other modules.

An overall system according to the embodiments of the present invention, may operate over a TCP/IP network or networks compatible with such a mode of transport. The system's traffic can travel on virtually any network configuration such as a closed LAN, WAN, secured network, unsecured network, internet or any combination thereof including VLAN and VPN configurations.

Now referring to FIGS. 2a-2n, a sequence of user screens are used to detail one embodiment of creating a control interface in the form of a user-friendly, personalized GUI for a user of a home control system. The user screens shown are ideally for the low level user. FIG. 2a shows an initial screen displaying instructions 305 at an upper portion 310 used to display instructions corresponding to each screen. FIG. 2b shows a display screen displaying optional animated or static objects or mascots 315, 320 which are used to assist the users having low level experience with computer interaction or programming. The screen in FIG. 2b displays a next icon 322 for a user to move to a next screen based on a selection being made. Often times, low level users are intimidated by computers but have fond experiences with pets and thus the mascots 315, 320 may alleviate a user's apprehension regarding the creation of the user-friendly GUI. Users may select from a library of objects, including animals, cars, motorcycles, flowers, trees and any other suitable objects. Users may also download or import their own digital photos to act as the guides or may also select no object guide.

Once the mascot has been selected (the cat 315 in this case) or denied, the process of configuring the system begins. FIG. 2c shows a home floor plan 325 from which the user may select rooms or areas wherein controllable equipment is located. As shown, rooms and areas 330-345 have been selected and thus highlighted. The cat mascot 315 is displayed at a top portion of the screen. After the rooms 330-345 are selected, a virtual keyboard 350, as shown in FIG. 2d, is displayed operable for the user to name the rooms or areas 330-345 as shown in FIG. 2e (patio in this instance). The basic entry level version, is designed to allow users to personalize their control environment by guiding the creative process within the modular structured system. For each room 330-345, the user is provided a list of devices 355 as shown in FIG. 2f. The list 355 may be from a general template configurable per room or specific to each room. List 355 depicts a TV, DVD, Receiver, Light and Security. The list 355 is an example and by no means exhaustive. For example, kitchen appliances, garage doors and any other electronic hardware device may be subject to the control interface. In FIG. 2g each device on the list 355 has been selected and therefore highlighted. Users are able to lock the selection of certain devices, for example the security device, from children or other unwanted individuals. As represented by FIG. 2h, a similar process is undertaken for each selected and named room.

In FIG. 2i, the user is able to name the desktop via the virtual keyboard 350. Multiple desktops are individually configurable. FIG. 2j shows a user screen displaying a selection of desktop skins 360-370. While only three skins 360-370 are shown, any number can be part of a library or downloaded by the user. As shown in FIG. 2k, users may personalize the GUI with select pictures 375 selected from a library or downloaded by the user. FIG. 2l provides an option to choose the desktop as a default desktop and FIG. 2m provides means for the user to configure another desktop. FIG. 2n shows a final screen displaying individual icons 375 for each room. In this case, only the family room has been configured, but once other rooms are configured, corresponding icons are displayed. The user is then free to click on any room and re-configure or edit the room configuration as desired or warranted.

Those skilled in the art will understand that the control interface may also be accessed via a remote computer, or via hand-held devices, such as cellular telephones and PDAs, and/or any electronic device with web browser support such that users may control hardware devices, in their homes or businesses, from any location.

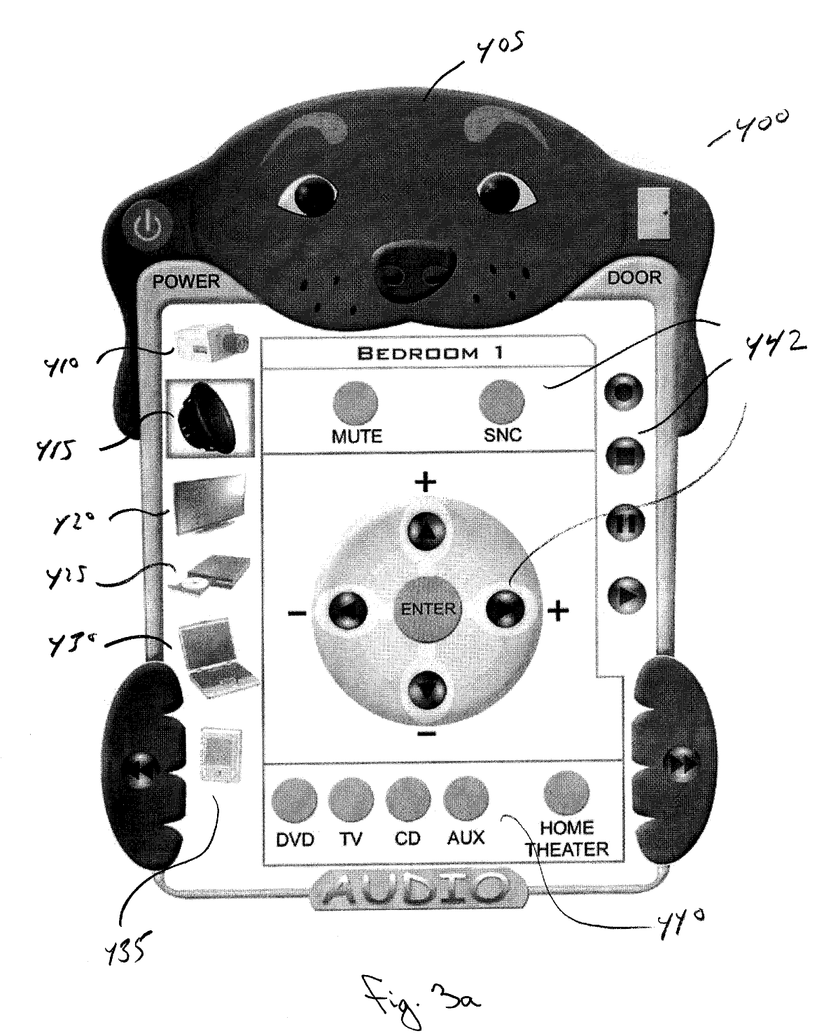

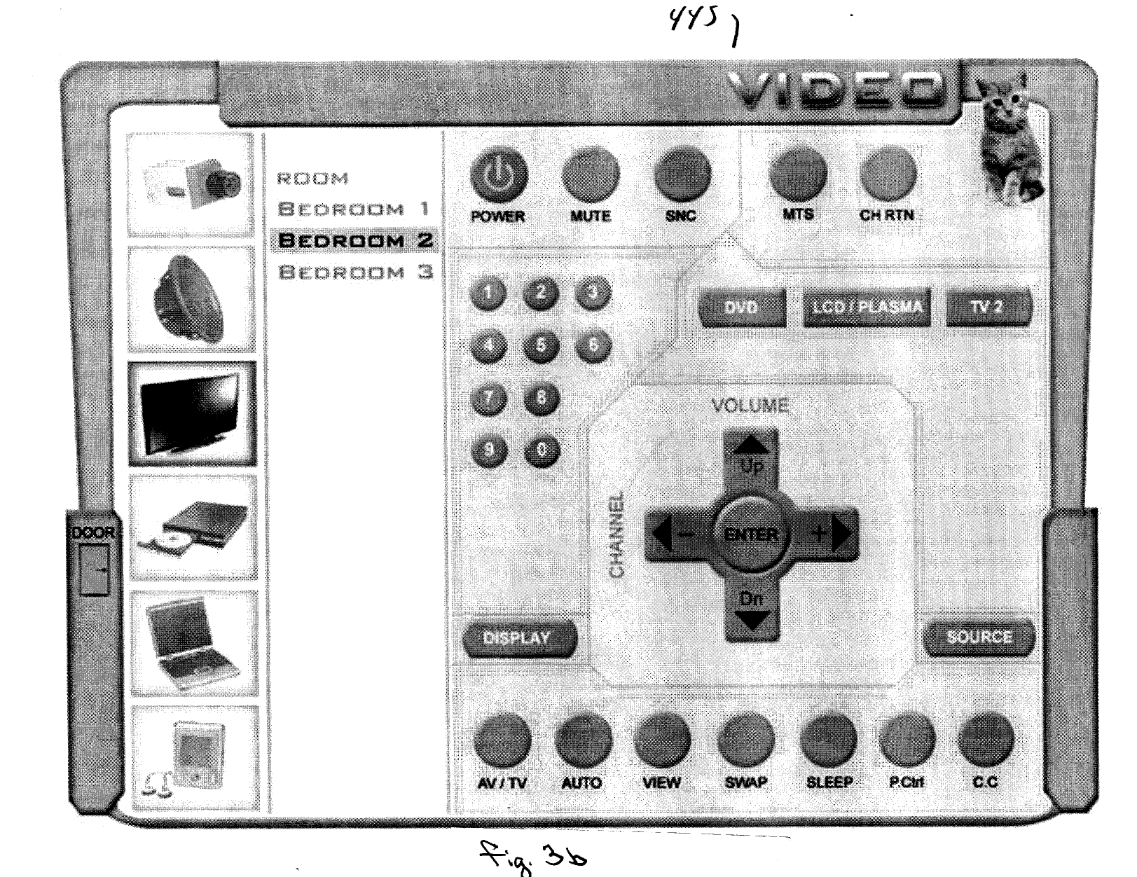

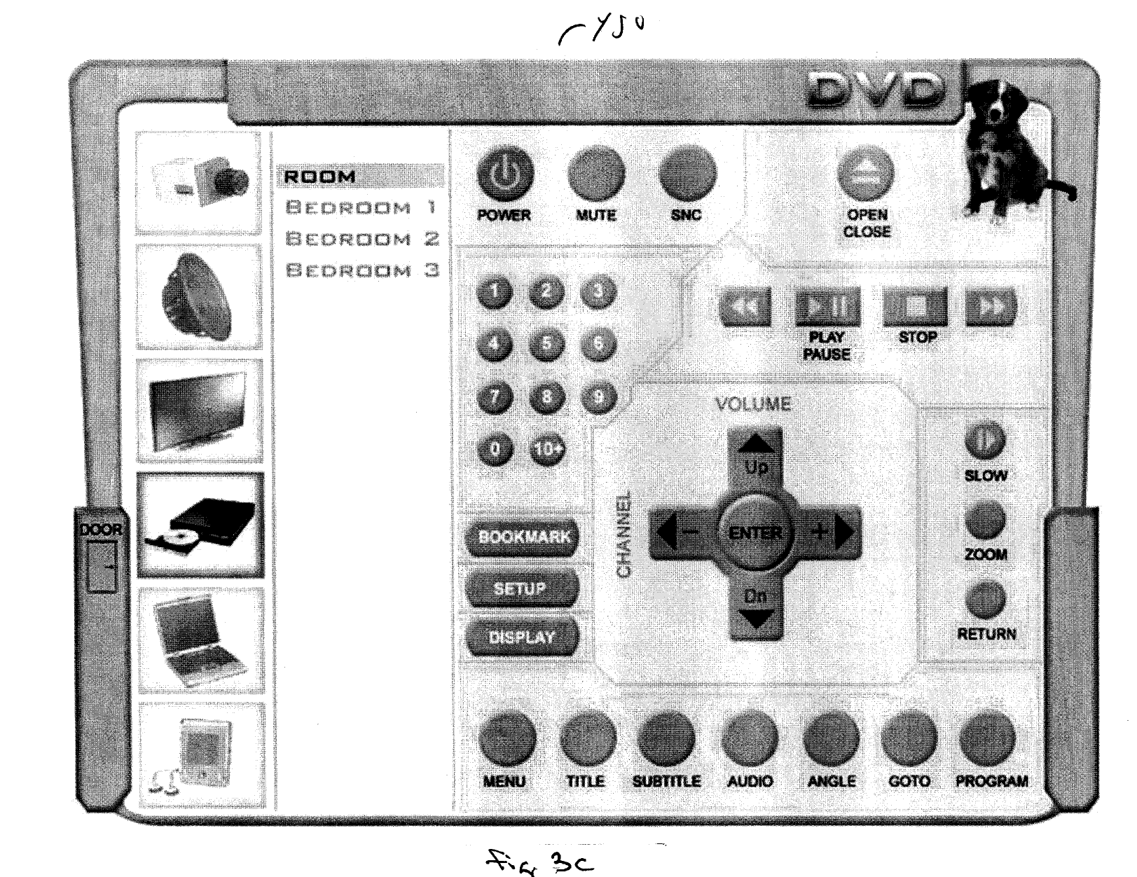

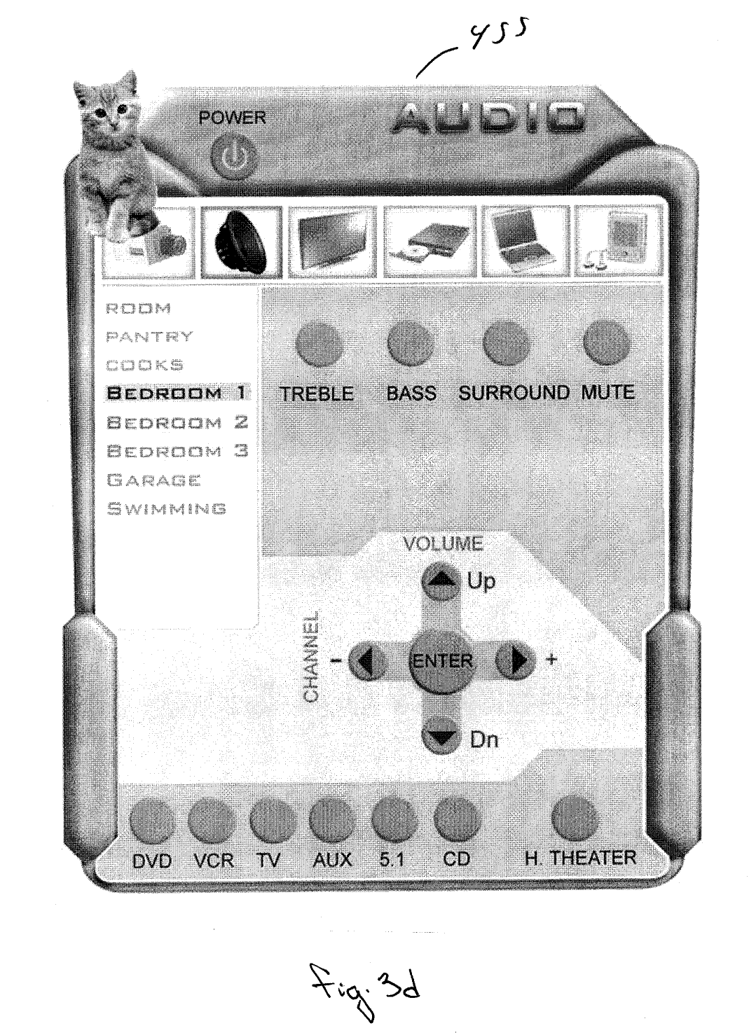

FIGS. 3a-3d show multiple different personalized GUIs. FIG. 3a shows an audio GUI 400 having a dog 405 as a mascot and open to a room entitled bedroom 1. A complete list of hardware devices 410-435 is displayed on a left-hand side of the screen while a bottom portion of the screen identifies hardware devices 440 in bedroom 1. Control buttons 442 permit a user, including a child, to operate the connected hardware devices 410435. FIGS. 3b and 3c show similar video and DVD GUIs 445, 450 for bedroom 2 and room, respectively. FIGS. 3b and 3c also display the cat mascot 315 and dog mascot 320 as described above. FIG. 3d shows an audio GUI 455 as accessed via a PDA.

Those skilled in the art will recognize that the system 100 will also support third-party, web-based applications including really simple syndication (RSS), short message service (SMS), instant messaging, voice messaging and other web-based applications. Therefore, the system platform 100 is able to utilize the power and flexibility of the Internet through third party applications with the only limitation being the capability of the user interface device. For example, a PDA may not be able to support voice messaging without the integration of additional hardware such as a Bluetooth headset.

Whether at home, work or on the road, the system 100 is a single platform designed to provide user access and control of the technology that pervades everyday life. Being web-based, the system platform 100 is easily extended to Internet services as described above. The first and second levels of the embodiments of the present invention provide the third-party applications at predefined locations within the control environment as designed within the templates of the system platform 100.

Although the invention has been described in detail with reference to several embodiments, additional variations and modifications exist within the scope and spirit of the invention as described and defined in the following claims.

We claim:

1. A method of creating a web-based universal remote control system comprising:
providing templates operable to allow users to create system modules, including GUI assembly modules, non-GUI assembly modules and/or device code block modules wherein the modules are open architecture and open source and comprise a template layer, an applications layer and a communications layer, said GUI assembly and non-GUI assembly modules being hooked into the applications layer and the device code block modules being hooked into the GUI assembly modules and non-GUI assembly modules, said GUI assembly modules and non-GUI modules able to mate with hardware control interfaces; and
providing means for a user to create a single interface for controlling multiple hardware devices connected to said system.

2. The method of claim 1 further comprising providing customizable templates.

3. The method of claim 2 further comprising providing means for users to personalize the templates into an environment reflecting the users' personalities, moods and interests.

4. The method of claim 1 wherein the GUI assembly and non-GUI assembly modules are based on a template specific to one or more web languages for which they are written.

5. The method of claim 1 further comprising buffering device code blocks to parse their device command payloads from the system through the hardware control interfaces.

6. The method of claim 1 further comprising loading device command payloads into the hardware control interfaces from the system or a device manufacturer's own library.

7. The method of claim 1 wherein the single interface for controlling multiple hardware devices connected to said system is a GUI or non-GUI.

8. The method of claim 7 wherein the GUI is accessible via a personal computer, tablet, desktop, web server appliance, hand-held device or any electronic device with web browser support.

9. The method of claim 7 wherein the non-GUI may comprise simple buttons or contact closures, re-tasked IR or RF signals, voltage or current sensing inputs or other types of signal sensing inputs, electric eye beams, ultrasonic reflection, voice recognition and/or biometrics.

10. The method of claim 1 further comprising providing a software development kit for advanced users.

11. A method of creating a web-based universal remote control system comprising:
utilizing open architecture and open source templates allowing users, based on their programming skill level, to create system modules, including GUI assembly modules, non-GUI assembly modules and/or device code block modules, said modules comprising a template layer, an applications layer and a communications layer wherein the template layer faces a user and said applications layer faces the communications layer;
creating a layered configuration by hooking said GUI and non-GUI assembly modules into the applications layer and hooking said device code block modules into the GUI assembly modules and non-GUI assembly modules, said GUI assembly modules and non-GUI modules able to mate with hardware control interfaces; and
providing means for a user to create a single interface for controlling multiple hardware devices connected to said system.

12. The method of claim 11 further comprising providing customizable templates.

13. The method of claim 12 further comprising providing means for users to personalize the templates into an environment reflecting the users' personalities, moods and interests

14. The method of claim 11 wherein the GUI assembly and non-GUI assembly modules are based on a template specific to one or more web languages for which they are written.

15. The method of claim 11 further comprising buffering device code blocks to parse their device command payloads from the system through the hardware control interfaces.

16. The method of claim 11 further comprising loading device command payloads into the hardware control interfaces from the system or a device manufacturer's own library.

17. The method of claim 11 wherein the single interface for controlling multiple hardware devices connected to said system is a GUI or non-GUI.

18. The method of claim 17 wherein the GUI is accessible via a personal computer, tablet, desktop, web server appliance, hand-held device or any electronic device with web browser support.

19. The method of claim 17 wherein the non-GUI may comprise simple buttons or contact closures, re-tasked IR or RF signals or voltage, current sensing inputs or other types of signal sensing inputs, electric eye beams, ultrasonic reflection, voice recognition and/or biometrics.

20. The method of claim 11 further comprising providing a software development kit for advanced users.

21. A web-based universal remote control system comprising:
open architecture system modules comprising GUI assembly modules, non-GUI assembly modules and/or device code block modules, said modules comprising a template layer, an applications layer and a communications layer wherein the template layer faces a user and said applications layer faces the communications layer;
a layered configuration of modules wherein said GUI assembly modules and non-GUI assembly modules are hooked into the applications layer and the device code block modules are hooked into the GUI assembly modules and non-GUI assembly modules, said GUI assembly modules and non-GUI modules able to mate with hardware control interfaces; and
a user interface operable for a user to control multiple hardware devices connected to said system.

22. The system of claim 21 wherein each GUI and non-GUI assembly module integrates with a device code block module.

23. The system of claim 21 further comprising customizable user templates for users to create the GUI assembly modules, non-GUI assembly modules and/or device code block modules.

24. The method of claim 23 further comprising providing means for users to personalize the templates into an environment reflecting the users' personalities, moods and interests

25. The system of claim 21 wherein the GUI assembly and non-GUI assembly modules are based on a template specific to one or more web languages for which they are written.

26. The system of claim 21 wherein the device code blocks are buffered to parse their device command payloads from the system through the hardware control interfaces.

27. The system of claim 21 wherein device command payloads are loaded into the hardware control interfaces from the system or a device manufacturer's own library.

28. The system of claim 21 wherein the user interface for controlling multiple hardware devices connected to said system is a GUI or non-GUI.

29. The system of claim 28 wherein the GUI is accessible via a personal computer, tablet, desktop, web server appliance, hand-held device or any electronic device with web browser support.

30. The system of claim 28 wherein the non-GUI may comprise simple buttons or contact closures, re-tasked IR or RF signals or voltage, current sensing inputs or other types of signal sensing inputs, electric eye beams, ultrasonic reflection, voice recognition and/or biometrics.

31. The system of claim 21 further comprising one or more web servers in communication with the system platform.

32. The system of claim 31 wherein the web server is a hardware control interface.
